(19) United States
(12) Patent Application Publication
(10) Pub. No.: US 2017/0341866 A1
(43) Pub. Date: Nov. 30, 2017

(54) METHOD FOR TRANSPORTING PELLETS, METHOD FOR MANUFACTURING PELLETS, AND METHOD FOR THE MANUFACTURE OF A MODULDED PRODUCT FROM PELLETS

(71) Applicant: SABIC Global Technologies B.V., Bergen op Zoom (NL)

(72) Inventors: Willy Joseph Dijsselbloem, Overpelt (BE); Stefan Gielen, Genk (BE)

(21) Appl. No.: 15/520,959

(22) PCT Filed: Oct. 12, 2015
(86) PCT No.: PCT/EP2015/073554

§ 371 Date: Apr. 21, 2017

(30) Foreign Application Priority Data
Oct. 23, 2014 (EP) 14190060.5

(51) Int. Cl. B65G 15/08; B29B 9/06; B29B 9/16; B29B 9/14; B65G 15/46; B29K 23/00

(52) U.S. Cl. CPC B65G 15/08; B29B 9/14; B65G 15/46; B29B 9/06; B29B 9/16; B29K 2039/08; B29K 2023/12

(57) ABSTRACT

Method for transporting pellets of a glass fibre reinforced thermoplastic polymer composition from a loading position to an unloading position, said pellets comprising a core and a thermoplastic polymer sheath surrounding said core, wherein the core comprises glass fibres extending in a longitudinal direction of the pellets and an impregnating agent, the method comprising loading pellets onto a non-vibrating belt conveyor at said loading position, conveying the pellets by means of said non-vibrating belt convey—or to said unloading position and unloading the pellets from said non-vibrating belt conveyor at said unloading position. Further methods are claimed as regards a process for manufacturing pellets of a glass fibre reinforced thermoplastic polymer composition and a process for the manufacture at a moulding position of a moulded product from pellets of a glass fibre reinforced thermoplastic polymer composition.

The present invention relates to a method for transporting pellets of a glass fibre reinforced thermoplastic polymer composition from a loading position to an unloading position, said pellets comprising a core and a thermoplastic polymer sheath surrounding said core, wherein the core comprises glass fibres extending in a longitudinal direction of the pellets and an impregnating agent.

The present invention further relates to a process for the manufacture at a moulding position of a moulded product from pellets of a glass fibre reinforced thermoplastic polymer composition, said pellets comprising a core and a thermoplastic polymer sheath surrounding said core, wherein the core comprises glass fibres extending in a longitudinal direction of the pellets and an impregnating agent.

The present invention further relates to the use of a non-vibrating belt conveyor.

The present invention further relates to a process for manufacturing pellets of a glass fibre reinforced thermoplastic polymer composition.

A process for manufacturing such pellets is known from WO 2009/080281, which process comprises the subsequent steps of:
a) unwinding from a package of at least one continuous glass multifilament strand containing at most 2% by mass of a sizing composition;
b) applying from 0.5 to 20% by mass of an impregnating agent to said at least one continuous glass multifilament strand to form an impregnated continuous multifilament strand;
c) applying a sheath of thermoplastic polymer around the impregnated continuous multifilament strand to form a sheathed continuous multifilament strand;
   characterised in that the impregnating agent is non-volatile, has a melting point of at least 20° C. below the melting point of the thermoplastic matrix, has a viscosity of from 2.5 to 100 cS at application temperature, and is compatible with the thermoplastic polymer to be reinforced.

According to WO 2009/080281 the sheathed continuous glass multifilament strand may be cut into pellets having a length of from 2 to 50 mm, preferably from 5 to 30 mm, more preferably from 6 to 20 mm and most preferably from 10 to 15 mm. The pellets may be used for producing articles by suitable moulding techniques, such as injection moulding, compression moulding, extrusion and extrusion compression moulding. Injection moulding is widely used to produce articles such as automotive exterior parts like bumpers, automotive interior parts like instrument panels, or automotive parts under the bonnet.

The glass filaments as disclosed and referred to in WO 2009/080281 are sometimes referred to as glass fibres. For the purpose of the present invention the terms filament and fibre as well as the terms multi-filament and multi-fibre may be used interchangeably and have the same meaning.

The skilled person will appreciate that the glass filaments (fibres) in the type of pellets produced in accordance with WO 2009/080281 are not (yet) dispersed in the thermoplastic polymer of the sheath. The present inventors have found that this may result in glass fibres separating from the pellets when such pellets are subjected to repetitive mechanical loads. Such repetitive mechanical loads may occur during transport of the pellets through a piping system, which is the commonly applied technique for transport of polymer based pellets. Such manner of transport however has the disadvantage that the separated fibres may cause blocking of the piping system and/or of filters, valves, outlets and the like that are used in the piping system. Such blocking may result in down time of the equipment and possible loss of production capacity. The present inventors generally refer to the above problems as the “free glass” problem. The term “free glass” may be used throughout this description as alternative to the amount of glass fibres (filaments) separating from the pellets.

A method for improving the coupling between the glass fibres and the thermoplastic polymer sheath is known from WO 2014/118144. Said method essentially comprising maintaining the pellets for a period of time at an elevated temperature of at least the melting temperature of the impregnating agent.

The present inventors found that, although the method of WO 2014/118144 is effective to a certain extent, the method proposed therein makes the manufacturing process more complex and less cost-effective. More importantly the present inventors found that the problem of clogging of the piping systems upon pneumatic transport of the pellets is of more relevance to the overall efficiency and cost of the process than the effect of improved coupling on other properties of the material. Or, a lower coupling of the glass fibres to the thermoplastic sheath can still provide good quality end-products.

WO 2007/008632 discloses a process to make a long fibre reinforced thermoplastic concentrate wherein a continuous fibre strand is coated with an aqueous melt-kneaded dispersion, dried and chopped. This publication discloses that coated pellets may be dried while being transported by means of a conveyor belt. The process for manufacture of pellets in WO 2007/008632 does not include a step of applying an impregnating agent to a multifibre strand prior to a step of sheathing the (impregnated) multifibre strand with a thermoplastic polymer. WO 2007/008632 is not concerned with the problem of free glass.

EP 0900638A2 discloses a long fiber-reinforced thermoplastic resin molding material in the form of pellets each having inorganic filaments arranged substantially in the same length and in parallel in the same direction in a matrix of a thermoplastic resin. In order to avoid fuzz EP 0900638A2 proposes to limit the amount of exposed ratio of cross-sections of inorganic filaments on the end surface of the long fibre-reinforced thermoplastic molding material. EP 0900638A2 does not disclose pellets comprising a core and a thermoplastic polymer sheath surrounding said core, wherein the core comprises glass fibres extending in a longitudinal direction of the pellets and an impregnating agent. Or, this publication does not disclose pellets having a core-sheath type of structure.

FR2270172 discloses a flexible belt conveyor consisting of an endless belt passing over two rollers, one of which is motor driven. The belt is flexible and is guided along the edges so as to close over the product being handled along the upper and lower runs.

In view of the prior art it is therefore an object of the invention to provide a method wherein the amount of free glass upon transport of the pellets is reduced to a minimum.

This object is met by the present invention wherein the method of transporting the pellets comprises loading pellets onto a non-vibrating belt conveyor at said loading position, conveying the pellets by means of said non-vibrating belt conveyor to said unloading position and unloading the pellets from said non-vibrating belt conveyor at said unloading position.

In the overall process from the point of manufacture of the pellets to the end-product in the form of a moulded article basically two different stages need to be recognised. The first stage being the manufacture of the pellets as such and the packaging of such pellets in a transport container. Such container is usually an octabin, but other packaging methods like ISO containers, FIBCs or plastic sacks may also be considered. This first stage is normally carried out at the premises of the manufacturer of the pellets.

In a second stage, usually at the converter, the transport container is unloaded and the pellets need to be transported from the transport container to the moulding equipment.

The present invention is applicable to both stages.

It is preferred that in either or both of the stages the transport of the pellets does not involve pneumatic conveying of pellets using a piping system.

The term non-vibrating belt conveyor as used herein is to be understood as a belt conveyor that does not purposely vibrate while moving from a loading position to an unloading position. The non-vibrating belt conveyor is preferably made of a flexible material, such as rubber, that allows to absorb some occasional vibrations that may nevertheless occur. In a preferred embodiment the non-vibrating belt conveyor comprises an endless flexible belt having two longitudinal outer edges perpendicular to a transport direction and wherein during the transport, the outer edges are folded towards each other so as to form a tube-like structure containing the pellets. Such belt conveyors are known in the art and sometimes referred to as hose belt conveyor, or enclosed belt conveyor. The general idea is that due to the flexible nature of the belt, said belt can be in an open position, wherein the outer edges are folded apart from one another, so that pellets can be loaded onto the belt, after which the outer edges can be folded towards each other so as to form a tube-like structure containing the pellets. The tube-like structure brings the advantage that the pellets are protected from contamination with for example dust or moisture which may be present on the outer side of the conveyor, in particular when the conveyor is used to transport the pellets from one building to an another. Belt conveyors of the type are for example disclosed in GB 2007178, DE 4036731, WO 93/08107 and U.S. Pat. No. 5,860,510. The manner in which the outer edges of the belt are combined is not of particular relevance as long as it allows for obtaining the tube-like structure and a substantially vibration free transport of the pellets. Commercial belt conveyers can be purchased for example from Continental under the brand name SICON. The dimensions of the conveyor belt are not of particular importance and are largely dictated by the type and amount of material that needs to be transported, as well as the distance between the loading and unloading position. Suitable widths may be from 500 to 1500 mm in open (i.e. flat) position. Multiple belt conveyors may be placed in series if appropriate.

In a preferred embodiment the pellets are continuously loaded onto the belt conveyor at the loading position and likewise continuously unloaded at the unloading position.

Since the separation of glass fibres from the pellets cannot be fully excluded it is preferred to clean the belt conveyor when while the conveyor is moving away from the unloading position. Obviously, while moving away from the unloading position the belt conveyor will not contain any pellets so that it need not be in the tube-like structure. This allows for cleaning of the side of the belt which is normally in contact with the pellets, for example contactless with pressurised air, or by contact with a brush or a cloth. Doing so allows the belt conveyor to remain in good clean condition and reduces damage.

### Sheath

The thermoplastic polymer of the thermoplastic sheath of the pellets preferably is polypropylene and the amount of glass fibre in the pellets typically is from 20 to 60 wt. % based on the weight of the pellets. Such materials are manufactured by Saudi Basic Industries Corporation under the brand name STAMAX. The skilled person will understand that the thermoplastic sheath may consist of polypropylene, but may also be based on a compound of polypropylene and further components or additives like fillers, pigments, UV stabilisers, anti-oxidants and the like.

The pellets of the present invention are manufactured by a wire-coating process such as for example disclosed in WO 2009/080821. This process, which is very different from pultrusion techniques, comprises the steps of

i) providing at least one continuous glass multifibre strand
ii) applying a thermoplastic polymer sheath around said at least one continuous glass multifibre strand,
iii) cutting the sheathed continuous glass multifibre strand into pellets at a cutting position.

Consequently, the pellets have a core-sheath structure wherein the thermoplastic polymer is contained only in the sheath and not in the core. The core contains the glass multifibre strand and preferably also an impregnating agent.

### Pellets

Preferably the pellets have a length from 5-50 mm, preferably from 5-30 mm, more preferably from 10-20 mm or 10-15 mm and most preferably from 12-15 mm. Pellets having a length of over 20 mm may be more difficult to process in an injection moulding equipment and/or would require modification of such equipment. Longer pellets, such as from 20 mm to 50 mm or 30-50 mm may be suitable for compression moulding techniques. The pellets used in accordance with the present invention preferably contain from 10 to 70 wt. %, preferably from 20 to 60 wt. % of glass fibres based on the weight of the pellets. The glass fibres in the pellets originate from glass multifibre strands, sometimes referred to as glass rovings. Such a roving is a continuous strand of glass fibres coated and held together by means of a sizing composition. Preferably, the continuous strand of glass fibres may contain from 500 to 10000 glass fibres per strand, more preferably from 2000 to 5000 glass fibres per strand. The linear density of the strand preferably is from 1000 to 5000 tex, corresponding to 1000 to 5000 grams per 1000 meter.

For the avoidance of doubt it is to be understood that in such a continuous strand or roving the glass fibres are also continuous. The glass fibres in the pellets of the present invention preferably have a thickness of from 5-50 μm preferably from 10-30 μm, more preferably from 15-25 μm. Usually the glass fibres are circular in cross section meaning the thickness as defined above would be the glass fibre diameter. The length of the glass fibres in a pellet typically corresponds to the length of the pellet. Small differences in length between the pellet and the glass fibres may nevertheless arise due to post-extrusion shrinkage of the thermoplastic polymer sheath or due to the applied pellet cutting technology. Such differences however are small and typically less than 10%, preferably less than 5%, more preferably less than 2% of the length of the pellet. The glass fibres generally lie in parallel to one another. For the avoidance of doubt it should be understood that the glass fibres as used in the present invention are not embedded in the thermoplastic polymer sheath. The glass fibres preferably contain at most 2 wt. % of a sizing composition.

### Impregnating Agent

For improved dispersion of the glass fibres during downstream moulding techniques an impregnating agent may be applied on the glass multifibre strand prior to the application of the thermoplastic polymer sheath.

The present invention is not limited to a certain impregnating agent, however it is highly preferred to use an impregnating agent as defined in WO 2009/080821. That is, the impregnating agent is non-volatile, has a melting point of at least about 20° C. below the melting point of the thermoplastic polymer sheath and has a viscosity of from 2.5 to 100 cS at application temperature. The viscosity of the impregnating agent is lower than 100 cS, preferably lower 5 than 75 cS and more preferably lower than 25 cS at application temperature. The viscosity of the impregnating agent is higher than 2.5 cS, preferably higher than 5 cS, and more preferably higher than 7 cS at the application temperature. An impregnating agent having a viscosity higher than 100 cS is difficult to apply to the continuous strand of glass fibres. Low viscosity is needed to facilitate good wetting performance of the glass fibres, but an impregnating agent having a viscosity lower than 2.5 cS is difficult to handle, e.g., the amount to be applied is difficult to control. The melting temperature of the impregnating agent is at least about 20° C., preferably at least 25° C. or at least 30° C. below the melting point of the thermoplastic polymer sheath. The application temperature of the impregnating agent is selected such that the desired viscosity range is obtained. The amount of impregnating agent that is applied depends inter alia on the thermoplastic polymer used for the sheath, the size (diameter) of the glass fibres of the continuous strand, and on the type of sizing that is on the surface of the glass fibres. According to the present invention, the amount of impregnating agent applied to the continuous strand of glass fibres should be higher than 0.5 wt. %, preferably higher than 2 wt. %, more preferably higher than 4 wt. %, more preferably higher than 6.wt % based on the weight of the glass fibres (including the sizing composition). The amount of impregnating agent should be lower than 20 wt. % preferably lower than 18 wt. %, more preferably lower than 15 wt. % more preferably lower than 12 wt. %. A certain minimum amount of impregnating agent is desired to assist homogeneous dispersion of glass fibres in the thermoplastic polymer matrix during moulding. An excess of impregnating agent may result in decrease of mechanical properties of the moulded articles. Suitable examples of impregnating agents for use in combination with polypropylene as the material for the sheath may comprise highly branched poly(alpha-olefins), such as polyethylene waxes, modified low molecular weight polypropylenes, mineral oils, such as, paraffin or silicon and any mixtures of these compounds. Preferably, the impregnating agent comprises a highly branched poly(alpha-olefin) and, more preferably, the impregnating agent is a highly branched polyethylene wax. The wax may optionally be mixed with a hydrocarbon oil or wax like a paraffin oil to reach the desired viscosity. WO 2009/080281 discloses as an impregnating agent a blend of 30 wt. % Vybar 260 (hyper branched polymer supplied by Baker Petrolite) and 70 wt % Paralux oil (paraffin, supplied by Chevron). The term non-volatile means that the impregnating agent does not evaporate under the application and processing conditions applied. In the context of the present invention, “substantially solvent-free” means that the impregnating agent contains less than 10% by mass of solvent, preferably less than 5% by mass solvent. Most preferably, the impregnating agent does not contain any solvent. The impregnating agent may further be mixed with other additives known in the art.

In a preferred embodiment the impregnating agent contains at least 70 wt. % of microcrystalline wax based on the weight of the impregnating agent. In that respect it is to be understood that the microcrystalline wax may be a single microcrystalline wax or a blend of several microcrystalline waxes. Microcrystalline waxes are well known materials. In general a microcrystalline wax is a refined mixture of solid saturated aliphatic hydrocarbons, and produced by de-oiling certain fractions from the petroleum refining process. Microcrystalline waxes differ from refined paraffin wax in that the molecular structure is more branched and the hydrocarbon chains are longer (higher molecular weight). As a result the crystal structure of microcrystalline wax is much finer than paraffin wax, which directly impacts many of the mechanical properties of such materials. Microcrystalline waxes are tougher, more flexible and generally higher in melting point compared to paraffin wax. The fine crystalline structure also enables microcrystalline wax to bind solvents or oil and thus prevents the sweating out of compositions. Microcrystalline wax may be used to modify the crystalline properties of paraffin wax. Microcrystalline waxes are also very different from so called iso-polymers. First of all, microcrystalline waxes are petroleum based whereas iso-polymers are poly-alpha-olefins. Secondly iso-polymers have a very high degree of branching of above 95%, whereas the amount of branching for microcrystalline waxes generally lies in the range of from 40-80 wt. %. Finally, the melting point of iso-polymers generally is relatively low compared to the melting temperature of microcrystalline waxes. All in all, microcrystalline waxes form a distinct class of materials not to be confused either by paraffin or by iso-polymers. The remaining at most 30 wt % of impregnating agent may contain a natural or synthetic wax or an iso-polymer. Typical natural waxes are animal waxes such as bees wax, lanolin and tallow, vegetable waxes such as carnauba, candelilla, soy, mineral waxes such as paraffin, ceresin and montan. Typical synthetic waxes include ethylenic polymers such as polyethylene wax or polyol ether-ester waxes, chlorinated naphtalenes and Fisher Tropsch derived waxes. A typical example of an iso-polymer, or hyper-branched polymer, is Vybar 260 mentioned above. In an embodiment the remaining part of the impregnating agent contains or consists of one or more of a highly branched poly-alpha-olefin, such as a polyethylene wax, paraffin. In a preferred embodiment the impregnating agent comprises at least 80 wt %, more preferably at least 90 wt % or even at least 95 wt % or at least 99 wt % of microcrystalline wax. It is most preferred that the impregnating agent substantially consists of microcrystalline wax. In an embodiment the impregnating agent does not contain paraffin. The term substantially consists of is to be interpreted such that the impregnating agent comprises at least 99.9 wt. % of microcrystalline wax, based on the weight of the impregnating agent.

The microcrystalline wax preferably has one or more of the following properties:
a drop melting point of from 60 to 90° C. as deter mined in accordance with ASTM D127
a congealing point of from 55 to 90° C. as determined in accordance with ASTMD938
a needle pen penetration at 25° C. of from 7 to 40 tenths of a mm as determined in accordance with ASTM D1321
a viscosity at 100° C. of from 10 to 25 mPa·s as determined in accordance with ASTM D445
an oil content of from 0 to 5 wt. % preferably from 0 to 2 wt % based on the weight of the microcrystalline wax as determined in accordance with ASTM D721

In an even more preferred embodiment the microcrystalline wax has all these properties in combination.

Any method known in the art may be used for applying the liquid impregnating agent to the continuous strand of glass fibres. Suitable methods for applying the impregnating agent include applicators having belts, rollers, and hot melt applicators. Such methods are for example disclosed in documents EP0921919, EP0994978B 1, EP0397505B1 and references cited therein.

The present invention further relates to a process for manufacturing a glass fibre reinforced thermoplastic polymer composition comprising the steps of

i) providing at least one continuous glass multifibre strand
ii) applying a thermoplastic polymer sheath around said at least one continuous glass multifibre strand,
iii) cutting the sheathed continuous glass multifibre strand into pellets at a cutting position,
iv) transporting the pellets with the method of the present invention,
v) filling a transport container with said pellets at a filling position.

In a preferred embodiment, step iv) carried out over at least 50%, preferably at least 75% ore even at least 90% of the distance between the cutting position and the filling position.

And even more preferably the transporting of pellets between the cutting position and the filling position does not involve pneumatic conveying of the pellets using a piping system.

In the embodiment where an impregnating agent is applied prior to step ii) and/or in embodiments where the at least one continuous multifibre strand is already provided with an impregnating agent, the process may further comprise also a step of maintaining the pellets for a period of time at an elevated temperature of at least the melting temperature of the impregnating agent prior to being loaded at the loading position onto the non-vibrating belt conveyor.

In another aspect the present invention further relates to a process for the manufacture at a moulding position of a moulded product from pellets of a glass fibre reinforced thermoplastic polymer composition, said pellets comprising a core and a thermoplastic polymer sheath surrounding said core, wherein the core comprises glass fibres extending in a longitudinal direction of the pellets and an impregnating agent, the process comprising transporting of the pellets to the moulding position at least in part with the method according to the present invention and moulding of the pellets into the moulded product.

In yet a further aspect the present invention relates to the use of a non-vibrating belt conveyor for the transport of pellets of a glass fibre reinforced thermoplastic polymer composition, said pellets comprising a core and a thermoplastic polymer sheath surrounding said core, wherein the core comprises glass fibres extending in a longitudinal direction of the pellets and an impregnating agent. The transport is performed from a loading position to an unloading position and comprises loading pellets onto the non-vibrating belt conveyor at said loading position, conveying the pellets by means of said non-vibrating belt conveyor to said unloading position and unloading the pellets from said non-vibrating belt conveyor at said unloading position

### EXEMPLARY EMBODIMENT

Pellets of a glass fibre reinforced polypropylene composition are prepared using the method as disclosed in WO 2009/080281. To that extent several glass multifibre strands are fed in parallel to an applicator for application of approximately 10 wt. % of an impregnating agent. After application of the impregnating agent each of the strands is wire-coated (or sheathed) with a sheath of a polypropylene composition. The sheathed strands are then cooled in a water bath and fed to a cutting device where they are cut into pellets of 12 mm in length. Next the pellets are loaded onto a belt conveyor of the type SICON available from Continental contitech and transported over a length of about 150 meter to a warehouse where the pellets are unloaded from the belt conveyor into a filling silo. The belt conveyor comprises a rubber belt with a width of about 650 mm in open position and a width of about 250 mm in closed (tube-like) position. Next, octabins are filled with pellets from the filling silo and the octabins are then ready for shipment to end users.

1. A method for transporting pellets of a glass fibre reinforced thermoplastic polymer composition from a loading position to an unloading position, said pellets comprising a core and a thermoplastic polymer sheath surrounding said core, wherein the core comprises glass fibres extending in a longitudinal direction of the pellets and an impregnating agent, the method comprising loading pellets onto a non-vibrating belt conveyor at said loading position, conveying the pellets by means of said non-vibrating belt conveyor to said unloading position and unloading the pellets from said non-vibrating belt conveyor at said unloading position.

2. The method of claim 1 wherein the thermoplastic polymer of the thermoplastic polymer sheath is polypropylene and the amount of glass fibre in the pellets is from 20 to 60 wt. % on the basis of the weight of the pellets.

3. The method of claim 1 wherein the non-vibrating belt conveyor comprises an endless flexible belt having two longitudinal outer edges perpendicular to a transport direction and wherein during the transport, the outer edges are folded towards each other so as to form a tube-like structure, said tube like structure containing the pellets.

4. The method according to claim 1 wherein the non-vibrating belt conveyor is cleaned continuously while moving away from the unloading position.

5. The method according to claim 1 wherein the method is a continuous method wherein pellets are continuously loaded to the non-vibrating belt conveyor at said loading position and continuously unloaded at said unloading position.

6. A process for manufacturing a glass fibre reinforced thermoplastic polymer composition comprising the steps of
i) providing at least one continuous glass multifibre strand
ii) applying a thermoplastic polymer sheath around said at least one continuous glass multifibre strand,
iii) cutting the sheathed continuous glass multifibre strand into pellets at a cutting position,
iv) transporting the pellets with the method of claim 1,
v) filling a transport container with said pellets at a filling position.

7. The process of claim 6 wherein the transporting of the pellets in step iv) carried out over at least 50% of the distance between the cutting position and the filling position.

8. The process of claim 6 wherein the transporting of pellets between the cutting position and the filling position does not involve pneumatic conveying of the pellets using a piping system.

9. A process for the manufacture at a moulding position of a moulded product from pellets of a glass fibre reinforced thermoplastic polymer composition, said pellets comprising a core and a thermoplastic polymer sheath surrounding said core, wherein the core comprises glass fibres extending in a longitudinal direction of the pellets and an impregnating agent, the process comprising transporting of the pellets to the moulding position at least in part with the method of claim 1 and moulding of the pellets into the moulded product.

10. (canceled)

11. The process of claim 9 wherein the non-vibrating belt conveyor is a flexible belt having two longitudinal outer edges perpendicular to a transport direction which outer edges may be or are folded towards each other during the transport so as to form a tube-like structure, said tube like structure containing the pellets.

12. The process of claim 11 wherein the non-vibrating belt conveyor is an endless belt conveyor.

13. The process of claim 7 wherein the transporting of the pellets in step iv) carried out over at least 75% of the distance between the cutting position and the filling position.
